(19) United States
(12) Patent Application Publication
(10) Pub. No.: US 2025/0329316 A1
(43) Pub. Date: Oct. 23, 2025

(54) TECHNIQUES FOR EDITING MUSIC AND USER INTERFACE THEREOF

(71) Applicant: Pozalabs Co., Ltd., Seoul (KR)

(72) Inventors: Sang Yi OH, Seoul (KR); Won Gil HUH, Seoul (KR)

(73) Assignee: Pozalabs Co., Ltd., Seoul (KR)

(21) Appl. No.: 18/638,023

(22) Filed: Apr. 17, 2024

(51) Int. Cl. G10H 1/00

(52) U.S. Cl. CPC G10H 1/0008; G10H 2210/325; G10H 2220/116; G10H 2220/126

(57) ABSTRACT

A variety of exemplary embodiments for editing music and user interface thereof are disclosed. In an exemplary embodiment, a method includes displaying a GUI that allows a user to edit music; wherein the GUI includes a melody region and a lyrics region, the melody region displays a melody portion of the music along the time axis and pitch axis, the lyrics region displays a lyrics portion corresponding to at least a part of the displayed melody portion, at least one pitch of the displayed melody portion and at least one character of the displayed lyrics portion corresponding to the at least one pitch are displayed, and substantially aligned along time axis, receiving a user input for modifying the displayed lyrics portion; and in response to the user input for modifying the lyrics portion, displaying a modified version of the lyrics portion on the lyrics region.

### BACKGROUND

The present disclosure relates to techniques for editing music and its user interface. More particularly, some embodiments relate to editing lyrics for music.

Melody and rhythm are important in music, and the lyrics need to be beautifully aligned with the melody and the rhythm in order to be musically moving. Writing lyrics that match the desired musical genre including rhythm and melody, is not easy for non- or atmosphere, musicians.

There are services or tools for music composition, creation, and editing that enable lyric editing. However, these existing solutions can be improved, for example, since they do not allow users to simultaneously view the melody line and lyrics in detail or observe the relationship between specific portions of the melody and lyrics. For example, in some software tools like digital audio workstations (DAW), users often need to zoom in on the user interface to edit lyrics after viewing the melody line at a normal size. Conversely, they may need to zoom out to see the flow of the melody at a glance after editing the lyrics. This is necessary because typical interfaces do not offer a pixel size suitable for both detailed lyric editing and at-a-glance viewing of the melody line.

Professional composers might be able to write or edit lyrics by memorizing a melody they have just seen or heard. However, this task can be challenging for non-musicians and may take significantly longer.

### SUMMARY

Therefore, there may be a need for technology that enables users to more easily or efficiently edit aspects of music, such as lyrics.

According to an aspect of the present disclosure, there is provided a method implemented by an electronic device with a display, a processor, and a memory comprising: displaying a graphical user interface (GUI) that allows a user to edit music; wherein the GUI includes a melody region and a lyrics region, the melody region displays a melody portion of the music along the time axis and pitch axis, the lyrics region displays a lyrics portion corresponding to at least a part of the displayed melody portion, and at least one pitch of the displayed melody portion and at least one character of the displayed lyrics portion corresponding to the at least one pitch are displayed, and substantially aligned along time axis, receiving a user input for modifying the displayed lyrics portion; and in response to the user input for modifying the lyrics portion, displaying a modified version of the lyrics portion on the lyrics region.

In some embodiments, the melody region may display a plurality of pitch boxes corresponding to the melody portion and each of the pitch boxes may have a length proportional to a duration of a respective pitch.

In some embodiments, the melody region may display at least one character from the lyrics portion in pitch boxes at specific time intervals and the at least one character displayed in a respective pitch box may correspond to time position of the respective pitch box. In some embodiments, the method may further comprise receiving a user input for selecting a pitch box among the plurality of pitch boxes displayed on the melody region; and in response to the user input for selecting a pitch box, displaying at least one character from the lyrics portion on the melody region. In some embodiments, the at least one character displayed on the melody region may represent a part of the lyrics portion corresponding to the time position of the selected pitch box.

In some embodiments, the melody portion to be displayed on the melody region may be selected based on the user's scroll.

In some embodiments, the melody portion to be displayed on the melody region may be selected based on the playback time of the music.

In some embodiments, the GUI further may include a playhead user interface element for indicating the playback time along the time axis.

In some embodiments, the at least one displayed pitch and the at least one displayed character substantially aligned in time axis may correspond to the playback time of the music.

In some embodiments, the displaying a modified version may comprise displaying a modified part and an unmodified part to be distinguished.

In some embodiments, the displaying a modified part and an unmodified part to be distinguished may comprise displaying the modified part and the unmodified part in different colors.

In some embodiments, the method may further comprise receiving a user input for synthesis instruction; and in response to the user input for synthesis instruction, providing music synthesized to reflect the modified version of the lyrics portion.

In some embodiments, the providing music synthesized may comprise playing the music synthesized.

In some embodiments, the displaying a modified version may comprise displaying a modified part and an unmodified part to be distinguished, and the providing music synthesized may comprise displaying the modified part and the unmodified part indistinguishably.

In some embodiments, the GUI may further include a tracks area for building a structure for the music.

In some embodiments, the lyrics region may be displayed overlapping a part of the melody region.

In some embodiments, the method may further comprise receiving a user input for lyrics view; and in response to the user input for lyrics view, providing a lyrics view area on the GUI, wherein the lyrics view area displays a larger portion of lyrics of the music than the lyrics region displays.

In some embodiments, the lyrics region may be displayed overlapping a part of the melody region and the lyrics view area may be scrollable perpendicular to the time axis of the melody region.

According to another aspect of the present disclosure, there is provided a method implemented by an electronic server system with a processor, and a memory comprising: transmitting data enabling an electronic device to display a GUI that allows for a user to edit music; wherein the GUI includes a melody region and a lyrics region, the melody region displays a melody portion of the music along the time axis and pitch axis, the lyrics region displays a lyrics portion corresponding to at least a part of the displayed melody portion, at least one pitch of the displayed melody portion and at least one character of the displayed lyrics portion corresponding to the at least one pitch are displayed, and substantially aligned along time axis, receiving information of a user input for modifying the displayed lyrics portion, from the electronic device; and in response to the information of the user input for modifying the displayed lyrics portion, transmitting data enabling the electronic device to display a modified version of the lyrics portion on the lyrics region.

In some embodiments, the method may further comprise receiving information of a user input for synthesis instruction, from the electronic device; and in response to the user input for synthesis instruction, generating music synthesized to reflect the modified version of the lyrics portion and providing the electronic device with the generated music for playback.

According to another aspect of the present disclosure, there is provided an electronic server system, comprising: a memory configured to store instructions; and a processor coupled to the memory, wherein, when executed by the processor, the instructions cause the electronic server system to: transmit data enabling an electronic device to display a GUI that allows for a user to edit music; wherein the GUI includes a melody region and a lyrics region, the melody region displays a melody portion of the music along the time axis and pitch axis, the lyrics region displays a lyrics portion corresponding to at least a part of the displayed melody portion, at least one pitch of the displayed melody portion and at least one character of the displayed lyrics portion corresponding to the at least one pitch are displayed, and substantially aligned along time axis, receive information of a user input for modifying the displayed lyrics portion, from the electronic device; and in response to the information of the user input for modifying the displayed lyrics portion, transmit data enabling the electronic device to display a modified version of the lyrics portion on the lyrics region.

According to another aspect of the present disclosure, there is provided a non-transitory recording medium that stores processor-readable instructions for an electronic apparatus, where the instructions enable the processor to perform the embodiments of this disclosure.

This overview is provided to introduce in a simplified form the selected concepts among those that are further explained in the detailed description below. The present disclosure is not intended to identify a core feature or essential feature of the subject matter of the claimed disclosure and is not intended to be used to limit the scope of the subject matter of the claimed disclosure. Also, the subject matter of the claimed disclosure is not limited to implementations that solve some or all of the problems mentioned in any part of the present specification. In addition to the above exemplary aspects, exemplary embodiments and features, additional aspects, embodiments, and features will become apparent with reference to the detailed description and drawings below.

Some exemplary embodiments of the present disclosure may have an effect including the following advantages. However, since it is not meant that all exemplary embodiments should include all of them, the scope of the present disclosure should not be understood as being limited thereto.

According to some exemplary embodiments, it may be possible to allow users to easily check the context of lyrics and the progression of melody, and provide a convenient way to edit them.

According to some exemplary embodiments, it may make it easy for non-musicians to edit lyrics by separating the lyric editing and melody checking functions.

According to some exemplary embodiments, it may allow multiple edits at once and require only one synthesis to implement them all, which helps writers stay focused and avoid interruptions.

According to some exemplary embodiments, it may allow users to customize lyrics to their favorite songs without any extra effort.

### BRIEF DESCRIPTION OF THE DRAWINGS

FIG. 1 illustrates a system for describing some exemplary embodiments of the present disclosure.

FIG. 2 illustrates an exemplary graphical user interface (GUI) for describing some exemplary embodiments of the present disclosure.

FIG. 3 is a drawing that enlarges a part of FIG. 2.

FIG. 4 is a flowchart illustrating music edition according to some embodiments of the present disclosure.

FIG. 5 and FIG. 6 are GUIs for describing some exemplary embodiments with respect to FIG. 3.

FIG. 7 is a GUI for describing some exemplary embodiments with respect to FIG. 3.

FIG. 8 is a GUI for describing some exemplary embodiments with respect to FIG. 2.

FIG. 9 is a block diagram showing an electronic apparatus which performs a method according to exemplary embodiments of the present disclosure.

### DETAILED DESCRIPTION

Since the description of the present disclosure is merely an exemplary embodiment for structural or functional description, the scope of the present disclosure should not be construed as being limited by the exemplary embodiments described in the text. That is, since exemplary embodiments may be changed in various ways and may have various forms, it should be understood that the right scope of the present disclosure includes equivalents that can realize the technical idea. In addition, the objectives or effects presented in the present disclosure may not mean that a specific exemplary embodiment should include all or only such effects, so the right scope of the present disclosure should not be understood as being limited thereto.

Meanwhile, the meaning of the terms described in the present disclosure should be understood as follows.

Terms such as “first”, “second”, and the like are intended to distinguish one component from another component, and the scope of rights should not be limited by these terms. For example, a first component may be referred to as a second component, and similarly, a second component may also be referred to as a first component.

When a component is referred to as being “connected” to another component, it may be directly connected to the other component, but it should be understood that other components may exist in the middle. On the other hand, when a component is referred to as being “directly connected” to another component, it should be understood that no other component exists in the middle. Meanwhile, other expressions describing the relationship between components, such as “between” and “immediately between” or “neighboring to” and “directly neighboring to”, should be interpreted in the same way.

Singular expressions should be understood to include plural expressions unless the context clearly indicates otherwise, and terms such as “include” or “have” are intended to designate the existence of features, numbers, steps, actions, components, parts, or combinations thereof, and should be understood not to preclude the possibilities of the existence or addition of one or more other features or numbers, steps, actions, components, parts, or combinations thereof.

In each step, identification codes (e.g., a, b, c, etc.) may be used for the convenience of explanation, and identification codes may not describe the order of each step, and each step may occur differently from the specified order unless a specific order is explicitly stated in the context. That is, each step may occur in the same order as the specified order, may be performed substantially simultaneously, or may be performed in the opposite order.

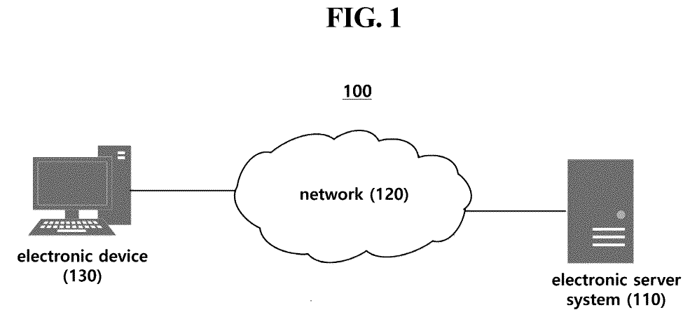

FIG. 1 illustrates a system for describing some exemplary embodiments of the present disclosure.

In some embodiments, as illustrated in FIG. 1, the system 100 may comprise an electronic server system 110, a network 120, and an electronic device 130. In these embodiments, a user may edit music using electronic device 130 which communicates with electronic server system 110 via the network 120. In other embodiments, unlike the illustration of FIG. 1, a user may edit music by using the electronic device 130 as a standalone device (i.e., without need to communicate with the electronic device 130). In these embodiments, electronic device 130 may have a software or hardware for editing music without the assistance of the electronic server system 110.

In some embodiments, the electronic server system 110 may comprise two or more server computers (e.g., web server, music generation server, etc.) which cooperate each other via communication means. In other embodiments, the electronic server system 110 may consist of one server computer.

In some embodiments, the network 120 may be a wired network such as typical internet. In other embodiments, the network 120 may be a wireless network such as cellular networks, Wi-Fi networks.

In some embodiments, the electronic device 130 may be a computer (e.g., desktop computers, laptops), a mobile device (e.g., smartphones, tablets), or any other devices which may communicate with the electronic server system 110 or may have a software or hardware for editing music without the assistance of the electronic server system 110.

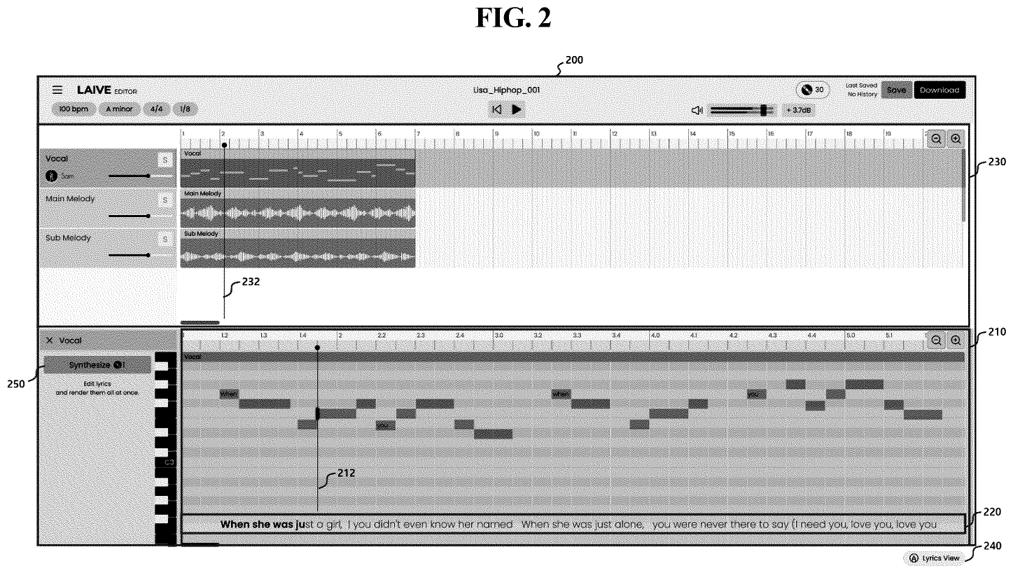

FIG. 2 illustrates an exemplary graphical user interface (GUI) for describing some exemplary embodiments of the present disclosure. In some embodiments, as illustrated in FIG. 2, a GUI 200 may include a melody region 210 and a lyrics region 220. In some embodiments, as illustrated in FIG. 1, the melody region 210 may display a melody portion of the music along the time axis and pitch axis. In some embodiments, the melody region 210 may further include a playhead user interface element 212 for indicating the playback time along the time axis. In some embodiments, as illustrated in FIG. 2, the lyrics region 220 may display a lyrics portion corresponding to at least a part of the displayed melody portion.

In some embodiments, at least one pitch near the playhead user interface element 212 and at least one character near the playhead user interface element 212 may be highlighted with a lighting effect as illustrated in FIG. 2, allowing the user to easily notice each part of both the melody and lyrics portions corresponding to the playback time.

In some embodiments, as illustrated in FIG. 2, the lyrics region 220 may be displayed overlapping a part of the melody region 210. In other embodiments, unlike what is shown in FIG. 2, the lyrics region 220 may be displayed in a separate area without overlapping the melody region 210. For example, the lyrics region 220 may be positioned either above or beneath the melody region 210 on the display.

In some embodiments, the melody portion to be displayed on the melody region 210 may be selected based on the user's scroll. In other embodiments, the melody portion to be displayed on the melody region 210 may be selected based on the playback time of the music.

In some embodiments, the lyrics portion to be displayed on the lyrics region 220 may be selected based on the user's scroll. In other embodiments, the lyrics portion to be displayed on the lyrics region 220 may be selected based on the playback time of the music.

In some embodiments, scrolling the melody region 210 and scrolling the lyrics region 220 may be synchronized with each other so that the melody and lyric portions are displayed in a time-aligned manner.

In some embodiments, as illustrated in FIG. 2, the GUI 200 may further include a lyrics view button 240.

In some embodiments, as illustrated in FIG. 2, the GUI 200 may further include a synthesis button 250.

In some embodiments, the GUI 200 may further include other user interface elements that make it easier to recognize, produce, or edit music. For example, as illustrated in FIG. 1, the GUI 200 may further include a tracks area 230 for building a structure for the music. In some embodiments, the tracks area 230 may further include a playhead user interface element 232 for indicating the playback time along the time axis.

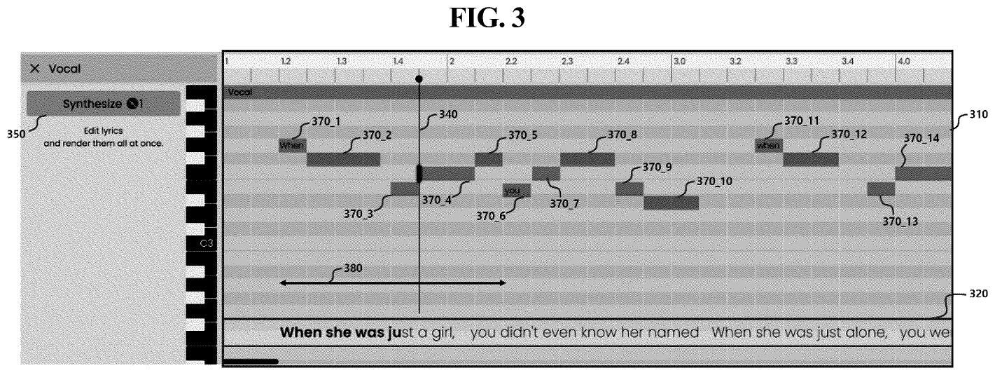

FIG. 3 is a drawing that enlarges a part of FIG. 2.

In some embodiments, a melody region 310 may display a plurality of pitch boxes 370_1, 370_2, . . . , 370_14 corresponding to the melody portion. Each of the pitch boxes 370_1, 370_2, . . . , 370_14 may have a length proportional to a duration of a respective pitch.

In some embodiments, at least one pitch (e.g., pitch box 370_3 or 370_4) of the melody portion displayed on the melody region 310 and at least one character (e.g., “just a girl”) of the lyrics portion displayed on the lyrics region 320 corresponding to the at least one pitch (e.g., pitch box 370_3 or 370_4) are displayed, and substantially aligned along time axis. For an example, as illustrated in FIG. 2, the at least one displayed pitch (e.g., pitch box 370_3 or 370_4) and the at least one displayed character (e.g., “just a girl”) substantially aligned in time axis may be determined based on the playback time of the music. For another example, the at least one displayed pitch and the at least one displayed character substantially aligned in time axis may be determined not by the playback time of the music, but by other factors, such as the midpoint of the displayed time axis.

In some embodiments, the melody region 319 may display at least one character (e.g., “when”, “you”) from the lyrics portion in pitch boxes (e.g., pitch boxes 370_1, 370_6) at specific time intervals (e.g., interval 380). In some embodiments, the at least one character (e.g., “when”, “you”) displayed in a respective pitch box (e.g., pitch boxes 370_1, 370_6) may correspond to time position of the respective pitch box (e.g., pitch boxes 370_1, 370_6).

In some embodiments, the specific time interval 380 may be a predetermined time duration (e.g., 8 seconds) or an interval (e.g., every four bars) in a musical context.

Embodiments that display at least one character in pitch boxes at specific time intervals may provide the user with additional support or information, complementing the lyric region. This may help the user easily or quickly understand the melody line and the corresponding lyrics portion.

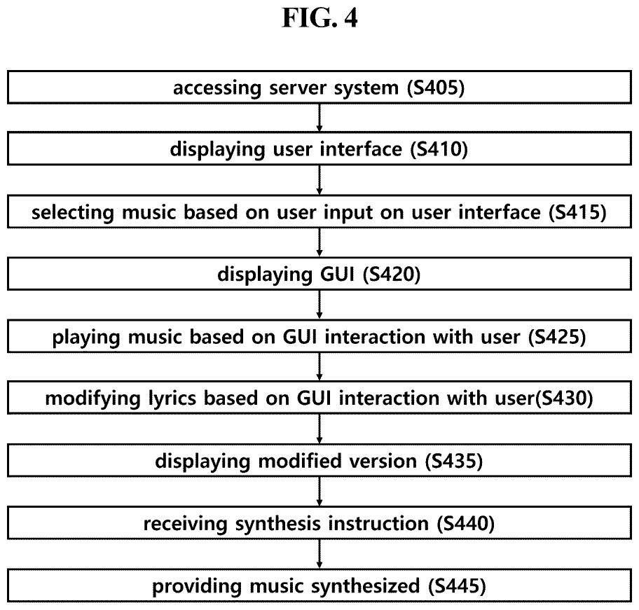

FIG. 4 is a flowchart illustrating music edition according to some embodiments of the present disclosure.

In some embodiments, music edition of FIG. 4 may be performed by an electronic device (for example, the electronic device 130 of FIG. 1).

In some embodiments, the electronic device may edit music by communicating with an electronic server system (for example, the electronic server system 110 of FIG. 1). In other embodiments, the electronic device may edit music as a standalone device without interaction with any other devices such as an electronic server system. In these cases, the electronic device may edit music using its hardware or software which may even perform operations typically handled by the electronic server system.

Hereinafter, some embodiments of the present disclosure will be described assuming that the electronic device 130 may edit music by communicating with the electronic server system 110.

In some embodiments, a user may use the electronic device 130 to access the electronic server system 110 in block S405. For example, the electronic device 130 may access the electronic server system 110 using a web browser.

In some embodiments, the electronic server system 110 may transmit data enabling the electronic device 130 to display a GUI that allows for a user to edit music for some blocks (e.g., some or all of blocks S415, S420, S425, S430, S435) illustrated in FIG. 4.

In some embodiments, the user may use the electronic device 130 to view a user interface such as a GUI provided by the electronic server system 110 in block S410.

In some embodiments, the user may use the electronic device 130 to interact with the user interface to select or generate music for editing in block S415.

In some embodiments, the user may use the electronic device 130 to interact with a GUI to play or edit music selected or generated in block S420. In some embodiments, the GUI used to play or edit music may be the one shown in FIG. 2.

In some embodiments, the user may use the electronic device 130 to play music using the GUI in block S425. In this case, while the music is being played, the GUI may display a melody line (i.e., a melody portion) according to the playhead user interface element 212 along with a lyric portion synchronized with the melody portion.

In some embodiments, the lyrics region 320 may visually distinguish between the part of the lyrics that has already been sung (“played part”) and the part that is yet to be sung (“non-played part”). The differentiation can be made through various visual cues such as color or font weight (bold versus non-bold as illustrated in FIG. 3). This feature enhances the user's ability to follow along with the song, particularly in karaoke or similar applications where timing and progression through the lyrics are important.

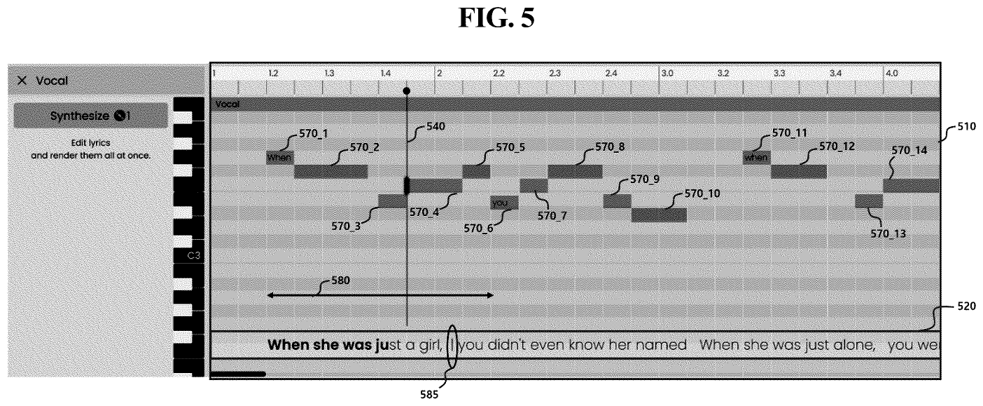

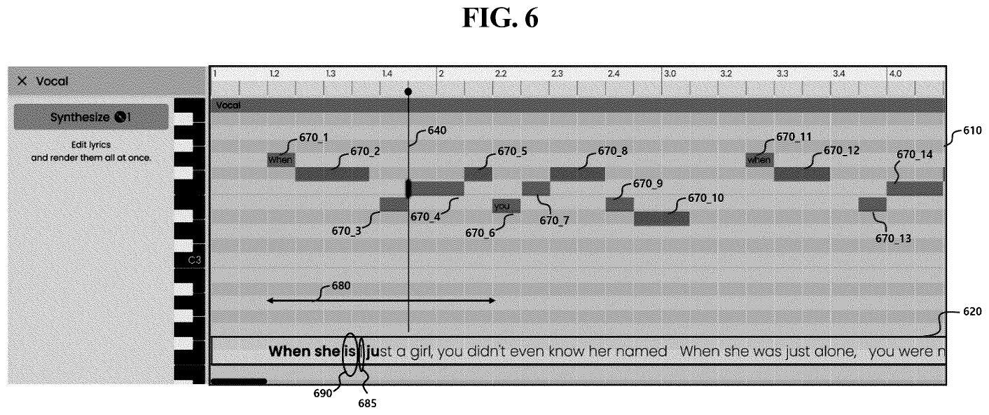

FIG. 5 and FIG. 6 are GUIs for describing some exemplary embodiments with respect to FIG. 3.

In some embodiments, the electronic device 130 may receive a user input for modifying the displayed lyrics portion in block S430. For example, the user may select a point in the lyric region (e.g., lyric region 320). In some embodiments, in response to selecting a point, a cursor (e.g., a cursor 585 in FIG. 5) for editing text may appear in the lyric region 520 as illustrated in FIG. 5.

In some embodiments, in response to the user input for modifying the lyrics portion, the electronic device 130 may display a modified version of the lyrics portion on the lyrics region in block S435. For example, in response to the user's editing lyrics (e.g., by replacing “was” with “is”) in the text editing mode supporting the cursor, the GUI 600 displays a modified version of the lyric portions, as illustrated in FIG. 6.

In some embodiments, the electronic device 130 may display a modified version by displaying a modified part and an unmodified part to be distinguished. For example, the electronic device 130 may display the modified part (e.g., “is” 690 in FIG. 6) and the unmodified part (the other portion in the lyric region) in different colors.

In some embodiments, the electronic server system 110 may receive information of a user input for modifying the displayed lyrics portion, from the electronic device 130 for block S430. In some embodiments, in response to the information of the user input for modifying the displayed lyrics portion, the electronic server system 110 may transmit data enabling the electronic device to display a modified version of the lyrics portion on the lyrics region for block S435.

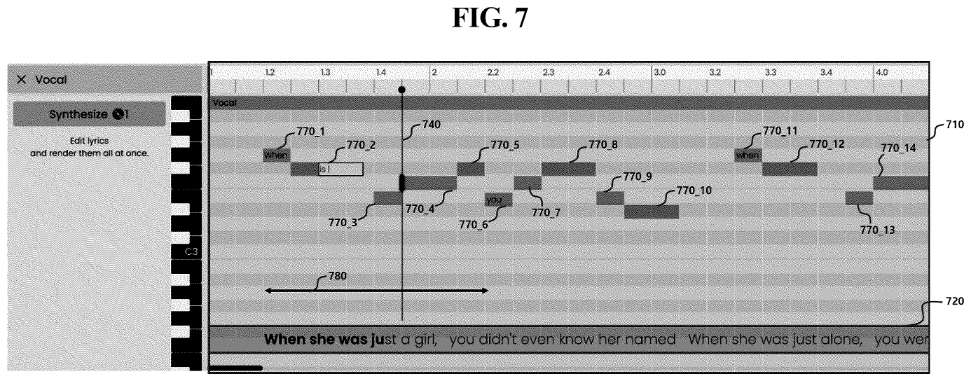

FIG. 7 is a GUI for describing some exemplary embodiments with respect to FIG. 3.

In some embodiments, the electronic device 130 may receive a user input for selecting a pitch box among the plurality of pitch boxes displayed on the melody region. For example, the user may select a point in a pitch box (e.g., pitch box 370_2) to view or edit the hidden characters corresponding to the pitch box.

In some embodiments, in response to the user input for selecting a pitch box, the electronic device 130 may display at least one character from the lyrics portion on the melody region. In some embodiments, the at least one character displayed on the melody region may represent a part of the lyrics portion corresponding to the time position of the selected pitch box. For example, the hidden characters (e.g., “is”) corresponding to the pitch box (e.g., pitch box 372_2) may appear with a cursor in the pitch box, as illustrated in FIG. 7. For another example, the hidden characters corresponding to the pitch box may appear not in the pitch box but near the pitch box, unlike what is shown in FIG. 7.

In some embodiments, the electronic device 130 may receive a user input for synthesis instruction in block S440. For example, the user may click the synthesis button 350 in the GUI to have music synthesized with the modified version (e.g., the lyrics modified during blocks S430 and S435).

In some embodiments, in response to the user input for synthesis instruction, the electronic device 130 may provide music synthesized to reflect the modified version of the lyrics portion in block S445. For one example of the electronic device 130's getting the music synthesized, the electronic server system 110 may receive information of a user input for synthesis instruction, from the electronic device 130 and then generate music to reflect the modified version of the lyrics portion and provide the electronic device 130 with the generated music for playback. The electronic server system 110 may synthesize music that reflects the modified version of the lyrics by using a vocal model selected by the user to sing the music with the modified version. In another example of the electronic device 130's getting the music synthesized, the electronic device 130 may synthesize the music without the assistance of any other devices.

For one example of the electronic device 130's providing music synthesized, the electronic device 130 may play the music synthesized. In another example of the electronic device 130's providing music synthesized, the electronic device 130 may display a modified version. In some embodiments, the modified version may be displayed so that the modified part and the unmodified part are indistinguishable, unlike the displayed lyric portion (e.g., lyrics region 620) before synthesis.

In some embodiments, when the user plays music in which a part of the lyrics has been modified but the changes have not yet been reflected in the music (e.g., before synthesis), the vocal part may remain unchanged, corresponding to the unmodified version of the lyrics. In this case, the vocal part may be played without any changes.

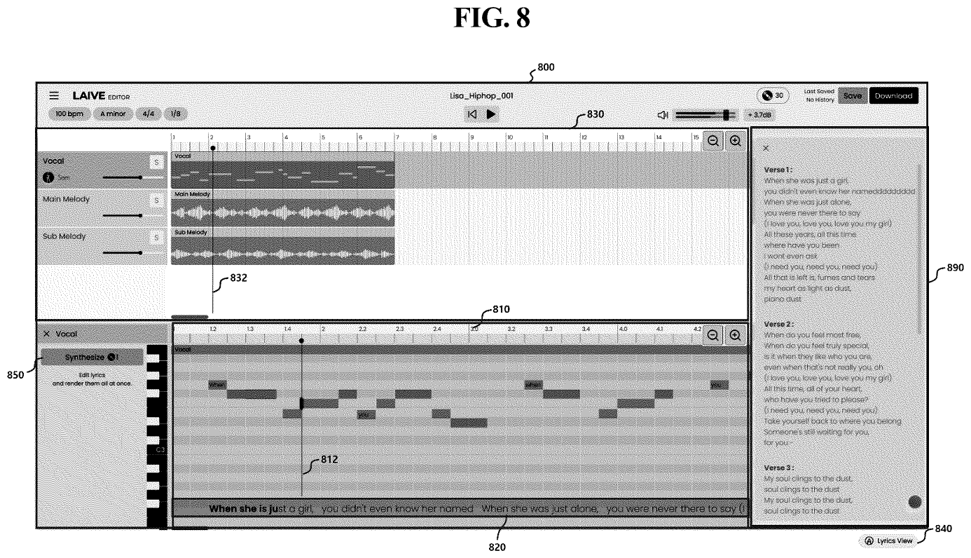

FIG. 8 is a GUI for describing some exemplary embodiments with respect to FIG. 2.

In some embodiments, the electronic device 130 may receive a user input for lyrics view. For example, the user may click the lyrics view button 240 in the GUI 200 to see more part of lyrics at a glance.

In some embodiments, in response to the user input for lyrics view, the electronic device 130 may provide a lyrics view area 890 on the GUI, as illustrated in FIG. 8. In some embodiments, the lyrics view area 890 may display a larger portion of lyrics of the music than the lyrics region 820 displays. In some embodiments, the lyrics view area 890 may be scrollable perpendicular to the time axis of the melody region, as illustrated in FIG. 8.

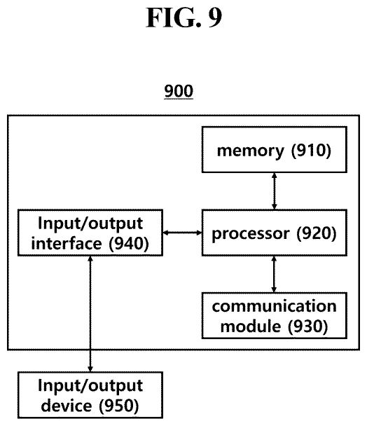

FIG. 9 is a block diagram showing an electronic apparatus (e.g., an electronic device or an electronic server system) which performs a method according to exemplary embodiments of the present disclosure. Although FIG. 9 describes the electronic apparatus 900 as one physical device, the electronic apparatus 900 may be implemented in a form in which a plurality of devices are interlocked with each other (e.g., distributed computing) according to exemplary embodiments.

In some exemplary embodiments, the electronic apparatus 900 may include a memory 910 and a processor 920, as shown in FIG. 9. In some other exemplary embodiments, all or some of the communication module 930, the input/output interface 940, and other units may be further included.

The memory 910 may be a recording medium readable by an electronic device (e.g., a computer), and may include permanent mass storage devices such as a random access memory (RAM), a read-only memory (ROM), and a disk drive. Herein, the ROM and the permanent mass storage devices may be separated from the memory 910 and included as a separate permanent storage device. Also, the memory 910 may store an operating system and at least one program code (as an example, a program such as a computer program stored in a recording medium included in the electronic apparatus 900 for controlling the electronic apparatus 900 to perform methods according to exemplary embodiments of the present disclosure). Such software components may be loaded from a recording medium readable by an electronic device separate from the memory 910. The recording medium readable by such a separate electronic device may include a recording medium readable by an electronic device such as a floppy drive, a disk, a tape, a DVD/CD-ROM drive, a memory card, and the like. In another exemplary embodiment, the software components may be loaded into the memory 910 through the communication module 930 rather than a recording medium readable by an electronic apparatus.

The processor 920 may be configured to process instructions of a program such as a computer program by performing basic arithmetic, logic, and input/output operations. The instructions may be provided to the processor 920 by the memory 910 or the communication module 930. For example, the processor 920 may be configured to execute an instruction received according to a program code loaded in the memory 910. In a more specific example, the processor 920 may sequentially execute an instruction according to a code of a computer program loaded in the memory 910 and perform the image processing according to an exemplary embodiment of the present disclosure. The communication module 930 may provide a function for communicating with other physical devices through a communication network such as a computer network. For example, an exemplary embodiment of the present disclosure may be performed in such a way that the processor 920 of the electronic apparatus 900 performs some of the processes of the present exemplary embodiment and other physical devices (e.g., electronic devices such as other computers which are not shown) of the communication network perform the remaining processes, so that the processing results are exchanged through a communication network and the communication module 930.

The input/output interface 940 may be a means for interfacing with the input/output device 950. For example, in an input/output device 950, the input device may include a device such as a keyboard or a mouse, and the output device may include a device such as a display or a speaker. In FIG. 9, the input/output device 950 may be depicted as a device separate from the electronic apparatus 900, but the electronic apparatus 900 may be implemented in such a way that the input/output device 950 is included in the electronic apparatus 900 according to an exemplary embodiment.

The apparatus described above may be implemented as a hardware component, a software component, and/or a combination of the hardware component and the software component. For example, the devices and the components described in exemplary embodiments may be implemented using one or more general-purpose computers or special-purpose computers, such as a processor, a controller, an arithmetical logic unit (ALU), a digital signal processor, a microcomputer, a field programmable gate array (FPGA), a programmable logic unit (PLU), a microprocessor, or any other device capable of executing and responding to instructions. The electronic apparatus 900 may perform an operating system (OS) and one or more software applications executed on the operating system. In addition, the electronic apparatus 900 may access, store, manipulate, process and generate data in response to an execution of software. For the convenience of understanding, it may be sometimes described that one electronic apparatus 900 is used, but those skilled in the art may recognize that the electronic apparatus 900 may include a plurality of processing elements and/or a plurality of types of processing elements. For example, the electronic apparatus 900 may include a plurality of processors or one processor and one controller. In addition, other processing configurations may be possible, such as parallel processors.

The software may include a computer program, a code, an instruction, or a combination of one or more thereof, and may configure the electronic apparatus 900 to operate as desired or may independently or collectively command the electronic apparatus 900. Software and/or data may be embodied in any type of machines, components, physical devices, computer storage mediums, or devices in order to be interpreted by an electronic apparatus 900 or to provide instructions or data to an electronic apparatus 900. The software may be distributed over networked computer systems and stored or executed in a distributed manner. The software and data may be stored in a recording medium readable by one or more computers.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above-described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

What is claimed is:

1. A method, comprising;
at an electronic device comprising a display, a processor, and a memory:
displaying a graphical user interface (GUI) that allows a user to edit music; wherein:
the GUI includes a melody region and a lyrics region,
the melody region displays a melody portion of the music along the time axis and pitch axis,
the lyrics region displays a lyrics portion corresponding to at least a part of the displayed melody portion, and
at least one pitch of the displayed melody portion and at least one character of the displayed lyrics portion corresponding to the at least one pitch are displayed, and substantially aligned along time axis,
receiving a user input for modifying the displayed lyrics portion; and
in response to the user input for modifying the lyrics portion, displaying a modified version of the lyrics portion on the lyrics region.

2. The method of claim 1, wherein the melody region displays a plurality of pitch boxes corresponding to the melody portion and each of the pitch boxes has a length proportional to a duration of a respective pitch.

3. The method of claim 2, wherein the melody region displays at least one character from the lyrics portion in pitch boxes at specific time intervals and the at least one character displayed in a respective pitch box corresponds to time position of the respective pitch box.

4. The method of claim 2, further comprising:
receiving a user input for selecting a pitch box among the plurality of pitch boxes displayed on the melody region; and
in response to the user input for selecting a pitch box, displaying at least one character from the lyrics portion on the melody region,
wherein the at least one character displayed on the melody region represents a part of the lyrics portion corresponding to the time position of the selected pitch box.

5. The method of claim 1, wherein the melody portion to be displayed on the melody region is selected based on the user's scroll.

6. The method of claim 1, wherein the melody portion to be displayed on the melody region is selected based on the playback time of the music.

7. The method of claim 6, wherein the GUI further includes a playhead user interface element for indicating the playback time along the time axis.

8. The method of claim 1, the at least one displayed pitch and the at least one displayed character substantially aligned in time axis correspond to the playback time of the music.

9. The method of claim 1, wherein the displaying a modified version comprises displaying a modified part and an unmodified part to be distinguished.

10. The method of claim 9, wherein the displaying a modified part and an unmodified part to be distinguished comprises displaying the modified part and the unmodified part in different colors.

11. The method of claim 1, further comprising:
receiving a user input for synthesis instruction; and
in response to the user input for synthesis instruction, providing music synthesized to reflect the modified version of the lyrics portion.

12. The method of claim 11,
wherein the providing music synthesized comprises playing the music synthesized.

13. The method of claim 11,
wherein the displaying a modified version comprises displaying a modified part and an unmodified part to be distinguished, and
the providing music synthesized comprises displaying the modified part and the unmodified part indistinguishably.

14. The method of claim 1, wherein the GUI further includes a tracks area for building a structure for the music.

15. The method of claim 1, wherein the lyrics region is displayed overlapping a part of the melody region.

16. The method of claim 1, further comprising:
receiving a user input for lyrics view; and
in response to the user input for lyrics view, providing a lyrics view area on the GUI,
wherein the lyrics view area displays a larger portion of lyrics of the music than the lyrics region displays.

17. The method of claim 16,
wherein the lyrics region is displayed overlapping a part of the melody region and
the lyrics view area is scrollable perpendicular to the time axis of the melody region.

18. A method, comprising;
at an electronic server system comprising a processor and a memory:
transmitting data enabling an electronic device to display a GUI that allows for a user to edit music; wherein:
the GUI includes a melody region and a lyrics region,
the melody region displays a melody portion of the music along the time axis and pitch axis,
the lyrics region displays a lyrics portion corresponding to at least a part of the displayed melody portion,
at least one pitch of the displayed melody portion and at least one character of the displayed lyrics portion corresponding to the at least one pitch are displayed, and substantially aligned along time axis,
receiving information of a user input for modifying the displayed lyrics portion, from the electronic device; and
in response to the information of the user input for modifying the displayed lyrics portion, transmitting data enabling the electronic device to display a modified version of the lyrics portion on the lyrics region.

19. The method of claim 18, further comprising
receiving information of a user input for synthesis instruction, from the electronic device; and
in response to the user input for synthesis instruction, generating music synthesized to reflect the modified version of the lyrics portion and providing the electronic device with the generated music for playback.

20. An electronic server system, comprising:
a memory configured to store instructions; and
a processor coupled to the memory, wherein, when executed by the processor, the instructions cause the electronic server system to:
transmits data enabling an electronic device to display a GUI that allows for a user to edit music; wherein:
the GUI includes a melody region and a lyrics region,
the melody region displays a melody portion of the music along the time axis and pitch axis,
the lyrics region displays a lyrics portion corresponding to at least a part of the displayed melody portion,
at least one pitch of the displayed melody portion and at least one character of the displayed lyrics portion corresponding to the at least one pitch are displayed, and substantially aligned along time axis,
receives information of a user input for modifying the displayed lyrics portion, from the electronic device; and
in response to the information of the user input for modifying the displayed lyrics portion, transmits data enabling the electronic device to display a modified version of the lyrics portion on the lyrics region.
